(19) United States
(12) Patent Application Publication
(10) Pub. No.: US 2007/0131685 A1
(43) Pub. Date: Jun. 14, 2007

(54) Plastic injection process for the manufacture of a lid for an electric capacitor and the product of such process

(76) Inventor: Eugenio Salvador Dominguez Gutierrez, C.P. Mexico, D.F. (MX)

Correspondence Address: ROBERTS, MLOTKOWSKI & HOBBES, P. O. BOX 10064, MCLEAN, VA, 22102-8064, US

(21) Appl. No.: 10/595,883

(22) PCT Filed: Jul. 20, 2004
(86) PCT No.: PCT/MX04/00049

§ 371 Date: Jan. 2, 2007

(51) Int. Cl. B29C 45/16; B65D 51/00

(52) U.S. Cl. 220/200; 264/255

(57) ABSTRACT

An injection molding process for the manufacture of a lid for an electric capacitor. The process employs a dual injection machine having a first mold half initially positioned on a fixed mold plate and a second mold half initially positioned on a rotatable mold plate and comprises the steps of injecting through a first injection unit a rigid thermoplastic resin into the initially positioned first and second mold halves; opening the mold halves of the dual injection machine and rotating the rotatable plate so that the second mold half is positioned on the fixed mold plate and the first mold half is positioned on the rotatable mold plate; injecting through a second injection unit a flexible thermoplastic resin into the repositioned first and second mold halves; and opening the mold halves of the dual injection machine and expelling the lid for an electric capacitor. A lid for use in the manufacture of an electrical capacitor is also provided.

### RELATED APPLICATIONS

This patent application claims priority to PCT/MX2004/000049, filed on Jul. 20, 2004, the contents of which are hereby incorporated by reference in their entirety.

### FIELD OF THE INVENTION

The present invention is directed generally to lids for use in electrical capacitors and to a process for their production.

### BACKGROUND OF THE INVENTION

Capacitor lids that function as covers, packing and as safety valves to exhaust gas from a capacitor casing, produced from two different materials, are known. The form of manufacture, materials and design of the lids currently existing in the marketplace have existed for over 20 years. Current lids are manufactured using more than one process and result in a high amount of waste, making their manufacture very expensive. Materials used in the lids currently existing in the marketplace are not injectable thermoplastic resins. and are of a much lower quality than those disclosed herein.

### SUMMARY OF THE INVENTION

In one aspect, provided is an injection molding process for the manufacture of a lid for an electrical capacitor. The process employs a dual injection machine having a first mold half initially positioned on a fixed mold plate and a second mold half initially positioned on a rotatable mold plate and comprises the steps of injecting through a first injection unit a rigid thermoplastic resin into the initially positioned first and second mold halves, opening the mold halves of the dual injection machine and rotating the rotatable plate so that the second mold half is positioned on the fixed mold plate and the first mold half is positioned on the rotatable mold plate, injecting through a second injection unit a flexible thermoplastic resin into the repositioned first and second mold halves and opening the mold halves of the dual injection machine and expelling the lid for an electric capacitor.

The process involves a manner of manufacturing a lid for an electric capacitor that utilizes a dual injection machine (4) in a single process, avoiding secondary activities and further involves the design of a lid of an electric capacitor that is formed using two thermoplastic resins, one rigid (17) and the other of a flexible, rubber-like material (18). The dual injection machine (4) may have different closing tonnage capacities, depending on the size of the molds that must be injected,

Two molds are mounted on the dual injection machine. They consist of two halves each (24)+(12) and (36)+(13) in order to inject the two thermoplastic resins in a single step. The parts of the molds (24) and (36) are mounted on the fixed plate (5) and parts (12) and (13) are mounted on the rotating plate (6). Once the rigid part of the lid (17) is injected, the machine (4) opens and the rotating plate (6) turns 180 degrees, taking (12) or (13) to the fixed part of the mold (36), which has the form of the rubber material part of the lid (18) in order to be injected (17), thus completing injection of the lid. The machine (4) opens and expels the finished lid and the rotating plate (6) turns 180 degrees to begin the process again.

The rotation of the halves of the molds (12) and (13) cause them to acquire different forms according to the side where they are located. This is achieved through a system adapted to permit certain components of the molds to glide, either in a backward or forward position, thus forming the configuration of the lid intended to be injected. This system may be activated through mechanic, hydraulic or pneumatic systems.

As will be described in more detail below, the dual injection machine used to manufacture the lids contemplated herein can completely manufacture a lid in a single process, avoiding secondary assembly and machining work. Since waste material may be reprocessed, a still less costly lid is produced, despite the fact that thermoplastic resins are generally more expensive.

In another aspect, the thermoplastic resins are introduced in the drying bins of the injector machine (4), which are in the injection unit (1) and (2) respectively. The rigid thermoplastic resin is introduced into the bin of injection unit (1), and the rubber-like, flexible, thermoplastic resin is introduced into the bin of injection unit (2). Either bin (1) or (2) may be selected for either one or both thermoplastic resins used in the process. Both resins must be dried for at least two hours before starting the process, the drying step continuing during the process as well, at a temperature between 70 and 100 degrees centigrade.

In yet another aspect, after the thermoplastic resins are completely dry, they are introduced into the barrel of the injection unit (1) and (2), where they are heated by means of heating elements to a temperature of between 150 and 350 degrees centigrade. This causes the thermoplastic resins to melt in order that they may be injected into the molds mounted on the plates (5) and (6) of the machine (4).

In still yet another aspect, the thermoplastic resin melted inside the barrel of the injection units (1) and (2) are injected so that they enter the molds and form part of the lid, depending on the position of the mold. As hereinafter described, mold sections (24)+(12) or (13) form the rigid portion of the lid (17); while (36)+(12) or (13) for the rubber-like portion of the lid (18).

In a further aspect, once the thermoplastic resin has been injected in the molds, the plates (5) and (6) of the machine open, and the rotating plate (6) turns 180 degrees to invert the position of the halves of molds (12) and (13), and the second thermoplastic resin is injected to form the lid. It must be noted that the manner in which the molds are inverted may vary, depending on the model of the injector machine (4) and the configuration of the machine, as there are double injection machines with a rotating plate (6) and injection machines with two fixed plates (5) instead of one rotating plate (6) and a fixed plate (5), as the one featured herein.

In a yet further aspect, waste resulting from the process described hereinabove is reprocessed, making the production of the lids contemplated herein less costly than the processes presently employed. This is due to the fact that current lids use thermo-fixed materials that cannot be reprocessed.

In a still yet further aspect, the thermoplastic resins used have a UL flame retardant rating of V2. This is advantageous since the resultant product is an electrical component. Materials used to manufacture lids currently existing in the marketplace lack this certification.

In another aspect, a lid for use in the manufacture of an electrical capacitor is provided. The lid comprises an upper cover portion molded from a rigid thermoplastic material, said upper cover portion having an outer surface, an inner surface and an outer perimeter, said upper cover portion having at least one orifice for passing an electrode therethrough and a vent orifice, a lower cover portion molded from a rubber-like thermoplastic material, said lower cover portion having an outer surface, an inner surface and an outer perimeter having a raised portion, said upper cover portion having at least one orifice for passing an electrode therethrough; wherein said outer surface of said lower cover portion is mated to said inner surface of said upper cover portion.

The products produced from the process described herein serve as upper lids for an electrical capacitor case. These lids offer a considerable improvement over lids already existing in the marketplace due, in part, to the thermoplastic resins utilized, which yield a flame-retardant UL rating of at least V2.

The products disclosed herein have an improved design that includes an edge in the rigid part (7) that serves as a mechanical gripping means so that when the rubber material part (18) is injected, it will adhere perfectly to the rigid part (17). This in turn, allows a packing to be formed with the rubber material in the perimetric part of the piece (3). Existing lids do not have perimetric packing (3), which is vital to assure the absence of leaks of the dielectric material contained within the capacitor, extending the useful life of the capacitor.

The capacitor lids disclosed herein have of two parts, a rigid part (17) in the upper portion, and a rubber-like portion (18) in the lower part. Additionally, they have two orifices crossing the two parts of the lid (14) and (15), from side to side. They also have a valve (16) to exhaust gas that is created when the capacitor overheats and exhausts such gas when it is produced. The valve is formed with an orifice in the rigid part (17) which is covered in the lower part by the rubber material (19), forming the valve (16). They also have an edge (7) in the rigid part (17) and another in the flexible part (18) that serves as a means for producing a mechanical grip, so that when the rubber material part is injected (18), it may adhere perfectly to the rigid part (17). They also have a rubber material contour (3) that serves to form a perimetric seal with the case when it is assembled, avoiding leakage of the dielectric from inside the capacitor, giving the electric capacitor a longer life. The use of the gas exhaust valve assures greater safety for the end user. The lids contemplated herein may assist in avoiding accidents, since they have a higher resistance to flames.

### BRIEF DESCRIPTION OF THE DRAWINGS

To assist those of ordinary skill in the relevant art in making and using the subject matter hereof, reference is made to the appended drawings, wherein:

FIG. 1 is a frontal view of the double injection machine (4) showing the injection units (1) and (2), as well as the fixed (5) and rotating (6) plates respectively,

FIG. 2 is a frontal view of the rotating plate (6) and of the fixed plate (5) showing the position where the parts of the turning parts of the mold (12) and (13) are placed;

FIG. 3 is an overhead view of the injection machine (4) showing the rotating (6) and fixed (5) plates, respectively, as well as of the two injection units (1) and (2);

FIG. 4 is a perspective of the interior part of the lid (18) showing the two orifices (14) and (15) where the terminals of the capacitor are riveted. These orifices cross the two parts of the lid from side to side, both the rigid part (17) and the rubber material part (18).

FIG. 5. is a perspective of the upper part of the lid (17) which shows the gas exhaust safety valve (16) and the rubber material contour (3) that serves as perimetric packing in the case where it is assembled, as well as mechanic grip in order that both materials do not separate. Valve (16) is formed by means of an orifice in the rigid part of the lid (17) and totally covered in the rubber material part of the piece (18).

FIG. 6 is a perspective view of the two components separately forming the lid, the rigid part serving as the upper lid of the capacitor (17), the edge (7) that serves as mechanical grip to secure non-detachment of the two parts, the rubber material (18) part that serves as packing when it is assembled, as well as safety valve for the exhaust of gases in case of overheating.

### DETAILED DESCRIPTION OF THE INVENTION

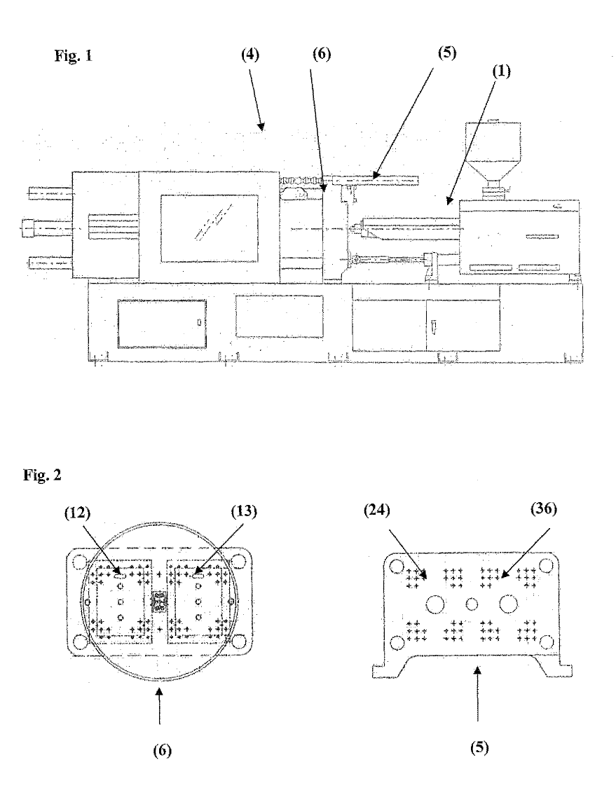

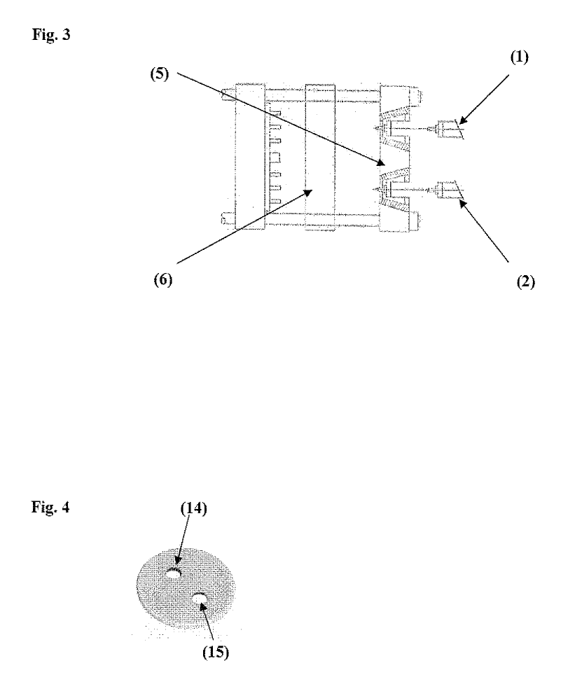

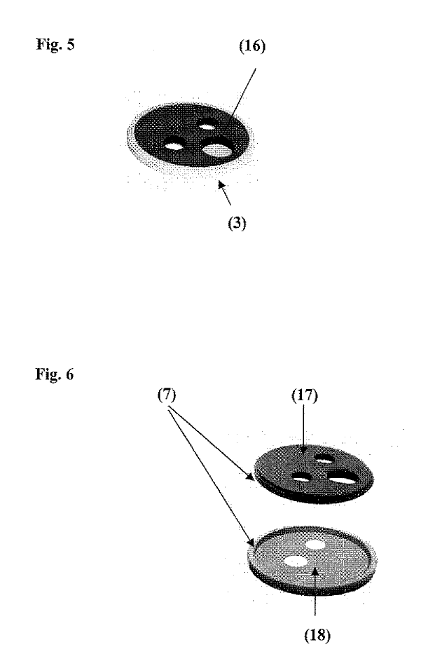

Reference is now made to FIGS. 1 through 6, wherein like numerals are used to designate like parts throughout.

This invention refers to a plastic lid that serves as a top cover of a case for an electric capacitor and the manner in which it is manufactured.

This invention involves the process followed to manufacture a plastic lid formed by two different thermoplastic resins injected in a dual injection machine. The lid serves as an upper cover for the case of a capacitor, as packing to seal the case and as a safety valve to exhaust gas in the case of overheating.

This invention is related to a new and novel design of a lid, which in turn, is manufactured through a novel procedure currently not existing in the capacitor industry. The lid serves as a cover for the case of a capacitor, as packing for air-tight sealing of the case, and as a safety valve for the exhaust of gas in the case of overheating of the capacitor. The lid is formed of two different thermoplastic resins, one rigid (17), located in the upper part of the lid and the other of a rubber-like, flexible material (18) in the lower part of the lid and the perimetric region of the lid (3). The upper part (17) serves as the lid itself of the capacitor casing, the lower part (18) serving as the packing for the case. Additionally, this part of the lid covers an orifice of the rigid part (17), forming a safety valve (16) for exhaust of gas. The perimetric contour (3) serves as the packing for the case, while the edge (7) of the rigid part (17) serves as a mechanical grip to prevent both materials from breaking lose.

The process used to manufacture the lid employs a dual injection machine (4) that uses two molds at the same time and may inject two different resins through the same process.

Product:

The lid proposed herein has an improved design that includes an edge (7) in the perimeter of the two parts (17) and (18), which serves as a mechanical grip to secure that both components are not separated. In turn, the perimeter formed by the rubber-like poriton serves as additional packing to help achieve better sealing when the lid is inserted in the case. The seal is vitally important as it assures the correct performance and the useful life of the capacitor.

The thermoplastic resins employed herein are entirely different and are of a better quality than the material used in current lids, with the benefit of a higher resistance to flames, which is extremely important, since this is an electric product. Materials employed herein are UL-V2 certified (flame resistance certification), which current lids lack and is highly important for any electric product.

It has two orifices (14) and (15) passing through the lid from side to side. This is where the terminals of the capacitor are riveted. The rubber-like portion (18) also serves as packing when the terminals of the lid are riveted. It has a valve (16) formed with an orifice in the rigid part (17) and, in the lower part, it is covered with the rubber material (18) that acts as a valve (16) for the exhaust of gases formed in the case of overheating of the capacitor. This is achieved by the breaking of the rubber-like material (18) in the part of the valve (16) resulting from the pressure produced by the gas produced from overheating.

As thermoplastic materials are of a better quality, this permits the gas exhaust valve (16) to secure that it breaks, always providing greater safety for the final user and thus avoid accidents.

The capacitor lid herein proposed consists of two parts, one rigid (17) and the other of a rubber-like, flexible material (18). It has two orifices (14) and (15) passing through the lid from side to side. This is where the terminals of the capacitor are riveted. The rubber-like, flexible material (18) serves as packing for the riveted terminals. The lid also has a valve (16) formed with an orifice in the rigid part (17), which when mated with the lower part formed of the rubber-like, flexible material (18), acts as a safety valve to exhaust gas from the capacitor through the breaking of the rubber-like, flexible material (18) by the pressure produced by the gas formed during overheating.

Additionally, also contemplated is a lid that includes an edge (7) in the rigid part (17) and another in the flexible part (18), that serves as a mechanical grip, so that when the rubber-like, flexible material part is injected (18), it adheres perfectly to the rigid part (17). This in turn, permits a packing to be formed with the rubber material (18) in the perimetric part of the piece (7). As may be appreciated by those skilled in the art, current lids lack perimetric packing, as they are not manufactured with a dual injection machine having two molds that handle the manufacturing process in a single step. As to the lid proposed herein, it has better sealing, which is vital to assure that no leakage of the dielectric occurs, prolonging the useful life of the capacitor. Contrary to materials used in lids existing in the marketplace, the thermoplastic resins propose have a V2 rating UL registration, and thus secure resistance to flame, a situation that is extremely important as it is an electric product.

Process:

The process proposed herein to manufacture the lid is unique, in that lids currently offered are manufactured using more than one process, which produces a large amount of waste. This waste cannot be reused, current lids employ thermo-fixed materials and cannot be reprocessed. By using a dual injection machine, the lid disclosed herein is produced in a single process, resulting in a cheaper lid, despite the fact that the thermoplastic resins are of a higher quality and more expensive than materials used in current lids, due to the savings achieved in the manufacturing processes.

There is an additional benefit achieved by not having waste, as the pieces are manufactured in a single process and faulty parts may be reprocessed since thermoplastic materials are being used. Additionally, this process offers improvements in the performance of the lid, as materials used in its manufacture, according to the novel process disclosed herein, are of a higher quality than those used in lids currently existing in the marketplace. Further improvements accrue from the fact that the gas exhaust valve (16) always pops-off and thus secures greater safety for the end user by avoiding accidents and having better resistance against flame.

Because of the use of the dual injection process and contrary to current lids, a perimetric seal (3) can be created with the rubber material contour and thus achieve a better sealing with the capacitor casing, avoiding leaks of the dielectric material that capacitors carry inside, assuring better performance and a longer useful life of the capacitor.

Detailed Explanation of the Process

The process is achieved through the unique and exclusive design of two steel molds consisting of two halves each (24)+(12) and (36)+(13) in order to inject the two thermoplastic resins in a single step and at the same time.

A dual injection machine (4) is required, where the halves of the two molds (24) and (36) are mounted on a fixed plate (5) and the two halves (12) and (13) on a rotating plate (6). The machine (4) has two injection units (1) and (2), one for each material injected, The rigid thermoplastic resin is processed in the injection unit (1), and the rubber material thermoplastic resin is processed in the injection unit (2).

The following are necessary to achieve injection of the lid with two thermoplastic materials:
A double injection machine (4);
The fixed part of the mold (24) that has the form of the rigid part of the lid (17) and the fixed part of the mold (36) that has the form of the rubber material part (18); and
The rotating part of the mold (12) and the rotating part of the mold (13). These parts of the molds are identical, but when the machine closes (12) and (13), they acquire the form of the lid which they will inject, depending on the side where they are located.

Rotation of the molds (12) and (13) making them acquire different forms according to the side where they are located, is achieved through a system adapted in the molds that permits certain components of the molds to shift, either in a backward or forward position, thus forming the figure of the lid intended to inject. This system may be activated through mechanic, hydraulic or pneumatic systems.

The following is an explanation of how the molds work:

The parts of the molds (24) and (36) are mounted on the fixed plate (5) and the parts (12) and (13) are mounted on the rotating plate (6).

The different configurations of the molds, when the machine closes, include:
(24)+(12) or (13)=injects the rigid part of the lid (17); and
(36)+(12) or (13)=injects the rubber material part of the lid (18).

Once the rigid part of the lid (17) is injected, the machine (4) opens and the rotating plate (6) turns 180 degrees taking (12) or (13) to the fixed part of the mold (36) which has the form of the rubber-like material part of the lid (18) in order to be injected on (17). This is when injection of the lid is completed.

The machine opens (4) and expels the finished lid, turns the rotating plate (6) 180 degrees, in order to begin the process again.

All patents, test procedures, and other documents cited herein, including priority documents, are fully incorporated by reference to the extent such disclosure is not inconsistent with this invention and for all jurisdictions in which such incorporation is permitted.

While the illustrative embodiments of the invention have been described with particularity, it will be understood that various other modifications will be apparent to and can be readily made by those skilled in the art without departing from the spirit and scope of the invention. Accordingly, it is not intended that the scope of the claims appended hereto be limited to the examples and descriptions set forth herein but rather that the claims be construed as encompassing all the features of patentable novelty which reside in the invention, including all features which would be treated as equivalents thereof by those skilled in the art to which the invention pertains. When numerical lower limits and numerical upper limits are listed herein, ranges from any lower limit to any upper limit are contemplated.

1-13. (canceled)

14. An injection molding process for the manufacture of a lid for an electrical capacitor, said process employing a dual injection machine having a first mold half initially positioned on a fixed mold plate and a second mold half initially positioned on a rotatable mold plate, comprising the steps of:
(a) injecting through a first injection unit into the first and second mold halves, as initially positioned, a rigid thermoplastic resin;
(b) opening the mold halves of the dual injection machine and rotating the rotatable plate so that the second mold half is positioned on the fixed mold plate and the first mold half is positioned on the rotatable mold plate;
(c) injecting through a second injection unit into the first and second mold halves, as repositioned in step (b), a flexible thermoplastic resin; and
(d) opening the mold halves of the dual injection machine and expelling the lid for an electric capacitor.

15. The process according to claim 14, wherein the rigid thermoplastic resin is dried for at least two hours before injection at a temperature of between about 70 and about 100 degrees centigrade.

16. The process according to claim 15, wherein the flexible thermoplastic resin is dried for at least two hours before injection at a temperature of between about 70 and about 100 degrees centigrade.

17. The process according to claim 14, wherein the flexible thermoplastic resin is dried for at least two hours before injection at a temperature of between about 70 and about 100 degrees centigrade.

18. The process according to claim 14, wherein prior to step (a), the rigid thermoplastic resin is introduced into the barrel of the first injection unit and heated by means of heating elements to a temperature of between about 150 and 350 degrees centigrade.

19. The process according to claim 18, wherein prior to step (c), the flexible thermoplastic resin is introduced into the barrel of the second injection unit and heated by means of heating elements to a temperature of between about 150 and 350 degrees centigrade.

20. The process according to claim 14, wherein prior to step (c), the flexible thermoplastic resin is introduced into the barrel of the second injection unit and heated by means of heating elements to a temperature of between about 150 and 350 degrees centigrade.

21. The process according to claim 20, further comprising the step of reprocessing thermoplastic resin waste produced by the process.

22. The process according to claim 14, further comprising the step of reprocessing thermoplastic resin waste produced by the process.

23. The process according to claim 14, wherein both the rigid thermoplastic resin and the flexible thermoplastic resin each possess an industry standard flame retardant certification rating.

24. The process according to claim 23, wherein the industry standard flame retardant certification rating is a UL rating of at least V2.

25. The process according to claim 14, wherein the lid is formed in a single process, without secondary assembly and machining.

26. A lid for use in the manufacture of an electrical capacitor, comprising:
(a) an upper cover portion molded from a rigid thermoplastic material, said upper cover portion having an outer surface, an inner surface and an outer perimeter, said upper cover portion having at least one orifice for passing an electrode therethrough and a vent orifice; and
(b) a lower cover portion molded from a rubber-like thermoplastic material, said lower cover portion having an outer surface, an inner surface and an outer perimeter having a raised portion, said upper cover portion having at least one orifice for passing an electrode therethrough;
wherein said outer surface of said lower cover portion is mated to said inner surface of said upper cover portion.

27. The lid of claim 26, wherein said vent orifice of said upper cover portion and said lower cover portion cooperate to form a safety valve to exhaust gas in the event of capacitor overheating.

28. The lid of claim 27, wherein said upper cover portion has a first diameter and said lower cover portion has a second diameter, said first and second diameters sized so that said outer perimeter of said upper cover portion fits within said raised portion of said outer perimeter of said upper cover portion.

29. The lid of claim 26, wherein said upper cover portion has a first diameter and said lower cover portion has a second diameter, said first and second diameters sized so that said outer perimeter of said upper cover portion fits within said raised portion of said outer perimeter of said upper cover portion.

30. The lid of claim 29, wherein said lower cover portion serves as packing for the capacitor's case.

31. The lid of claim 26, wherein said lower cover portion serves as packing for the capacitor's case.

32. The lid of claim 26, wherein said upper cover portion and said lower cover portion are produced from a thermoplastic resin possessing an industry standard flame retardant certification rating.

33. The lid of claim 32, wherein the industry standard flame retardant certification rating is a UL rating of at least V2.
